(19) United States
(12) Patent Application Publication
(10) Pub. No.: US 2005/0261958 A1
(43) Pub. Date: Nov. 24, 2005

(54) Business method for providing the consumer with product information at the point of sale

(76) Inventor: Robert Hageman, Austin, TX (US)

Correspondence Address: DAVID G. HENRY;7th Floor, 900 Washington Avenue, P.O. Box 1470, Waco, TX, 77603-1470, US

(21) Appl. No.: 10/848,555

(22) Filed: May 18, 2004

(51) Int. Cl. G06F 17/60

(52) U.S. Cl. 705/14

(57) ABSTRACT

The invention is of a novel business method for presenting pre-recorded promotional presentations to retail consumers at the point of sale. The system plays a short consumer message upon activation by the consumer and educates the consumer about some aspect of the product for sale. This novel business method is a way for marketers to make individualized contact with the consumer at the point of sale without the use of sales personnel.

### BACKGROUND OF THE INVENTION

1. Field of the Invention

The present invention relates to business methods, and business methods in the retail marketing area in particular.

2. Background Information

One of the main challenges in the retail marketing arena is making your product stand out from the competition. For instance, when one enters the typical wine shop the rows of nearly identical bottles of wine can be very intimidating and confusing for the average consumer. Many consumers don't know the difference between a merlot and a reisling, much less a merlot and a cabernet. Further, the average consumer does not know which year a particular wine is known for its full-bodied flavor and which for its spicy finish. In fact, many consumers are not even sure which wine goes best with beef and which with chicken. The fact is that most wine buyers don't want to be disappointed with their selection, whatever the price range or varietal, when they get home. They want the best wine for their money.

The best solution, of course, would be to have a knowledgeable and personable sales representative available to answer the inevitable questions regarding your product. This, unfortunately, is impractical because of cost and because store owners would not approve of a plethora of sales representatives, for each class or type of wine, harassing the costumers with competing sales pitches. Some shoppers are even skeptical of information given on a particular wine by a store representative because they feel that person could be steering them to wine that wasn't really selling well. Consumers really want to make a good choice, but it has to be theirs. Information about the wine is sometimes placed on the labels, but that information is usually on the back of the bottle and in very small print, making it hard for the potential consumer to quickly learn about a particular wine. Another method wine makers and their marketers use to educate consumers at the store is placement of Point of Sale (POS) literature at or near the individual product line. Larger print, fancy pictures, endorsements from notable personalities, etc., can direct consumer attention to a particular brand. Retailers seldom allow this strategy because of compact shelf design, the sheer number of different wines offered, the limited space allotted for wine bottles at some stores, and, most importantly, the clutter all the signs would generate. It would be unacceptable to the store owner for the consumer to be able to barely see the wine for all of the POS literature. The answer is an unobtrusive, individualized marketing tool that draws in the consumer quickly, educates the consumer, and convinces the consumer to choose a particular product at the point of sale. The answer is the present invention.

### SUMMARY OF THE INVENTION

In view of the foregoing, it is an object of the present invention to provide a novel business method, which benefits manufacturers, retail marketers, and consumers.

It is another object of the present invention to provide a novel business method for promoting and selling many different types of retail products at the consumer level.

It is a further object of the present invention to provide a novel business method for promoting and selling many different types of retail products by targeting and educating the consumer in a retail setting at the point of sale.

In satisfaction of these and other related objectives, Applicant's present invention provides a novel business method and associated apparatus which, through the use of microchip audio technology, delivers at the point of sale an individualized message to the consumer at the retail level in order to educate the consumer, and in order to promote the sales of a marketer's product. The present system and associated method will enable a retailer to provide consumers with information pertinent to their buying decisions at a time when the information will have the greatest impact.

Applicant's approach to the problem described above is certainly simple, but it is equally unobvious. Applicant's novel business method facilitates consumer buying decisions and maximizes retail marketer's attempts to promote their products at the point of sale.

### DETAILED DESCRIPTION OF THE PREFERRED EMBODIMENT

Audio messages to the consumer are certainly not new, but the their use at the point of sale, upon activation by the consumer, in order to educate and promote sales, is new and unobvious.

The present system involves an individual voice unit which includes a power means, which most likely would be a small battery, either replaceable, rechargeable, or nonreplaceable, depending upon economic factors and convenience for the marketer. The individual voice unit would also include a speaker such as conventionally found. A playback audio chip recorded with a 20 second promotional and/or informational message would also be a part of the individual voice unit. Each voice unit would have a custom message for the particular product type being sold.

The activation means used in this invention can be an external button that would be pushed by the consumer in order to activate the audio message, or a motion sensor that would automatically deliver the audio message when the consumer stepped up to the product display. The small individual voice unit itself would be attached by conventional means to the shelf, box, carton, or other method of product display, in plain view of the consumer with an invitation to push the button for more information, or it could be out of sight with only the activation button or sensor visible. Or, the unit could be camouflaged in a way that would enhance the product display itself, such as in a cluster of grapes at a display of wine.

Although the invention has been described with reference to specific embodiments, this description is not meant to be construed in a limited sense. Various modifications of the disclosed embodiments, as well as alternative embodiments of the inventions will become apparent to persons skilled in the art upon reference to the description of the invention. It is, therefore, contemplated that the appended claims will cover such modifications that fall within the scope of the invention.

1. A business method for individualized marketing of retail products to consumers comprising the steps of:
selecting an individual voice unit comprising power means, speaker, playback chip, and activation means;
actuating said playback chip with consumer message;
attaching said individual voice unit to retail product display; and
upon activation, delivering said consumer message to potential buyer.

2. The business method of claim 1 wherein said retail products comprising a plurality of varietal wines and said consumer message specific to each of said plurality.

3. The business method of claim 1 wherein said activation means is a motion sensor.
